(19) United States
(12) Patent Application Publication
(10) Pub. No.: US 2024/0193461 A1
(43) Pub. Date: Jun. 13, 2024

(54) CONTENT DISTRIBUTION

(71) Applicant: Google LLC, Mountain View, CA (US)

(72) Inventor: Timothy Chun-Wai Au, Milpitas, CA (US)

(21) Appl. No.: 18/008,562

(22) PCT Filed: Aug. 22, 2022
(86) PCT No.: PCT/US2022/041039

§ 371 Date: Dec. 6, 2022

(51) Int. Cl. G06N 20/00; G06N 5/022; G06N 7/01

(52) U.S. Cl. CPC G06N 20/00; G06N 5/022; G06N 7/01

(57) ABSTRACT

Methods, systems, and apparatus, including computer programs encoded on a computer storage medium, for adjusting distribution criteria of digital component in one or more geographical regions. Methods include obtaining data quantifying digital component distribution in a first and a second region during a first predetermined period of time. A machine learning model is generated to predict a first outcome quantifying digital component distribution in the first region based on a correlation between digital component distribution in a first and a second region. Data is obtained that quantifies digital component distribution in the first region during a second predetermined period of time and a predicted second outcome is generated that quantifies digital component distribution during the second predetermined period of time. The predicted second outcome is compared with the digital component distribution in the first region and distribution criteria is adjusted for the first region based on the comparison.

### BACKGROUND

This specification relates to analysis of content item distribution strategies.

A client device can use an application (e.g., a web browser, a native application) to access a content platform (e.g., a search platform, a social media platform, or another platform that hosts content). The content platform can display, within an application launched on the client device, digital components (a discrete unit of digital content or digital information such as, e.g., a video clip, an audio clip, a multimedia clip, an image, text, or another unit of content) that may be provided by one or more content source/platform.

Changes to digital component distribution criteria that guide the selection and distribution of digital components, for various reasons, such as improved selection of digital components can positively or sometimes negatively impact the quality of the distribution of digital components. Methods can be implemented to analyze the distribution of digital components to client devices located in different geographic locations by counterfactually predicting the distribution of digital components that would have been observed if the digital component distribution criteria that guide the distribution of data had not been altered.

### SUMMARY

In general, one innovative aspect of the subject matter described in this specification can be embodied in methods including the operations of obtaining, based on digital component distribution criteria, data quantifying digital component distribution in a first region during a first predetermined period of time; obtaining data quantifying digital component distribution in a second region during the first predetermined period of time; generating a machine learning model that is configured to predict a first outcome quantifying digital component distribution in the first region based on a correlation between the data quantifying digital component distribution in the first region during the first predetermined period of time and the data quantifying digital component distribution in the second region during the first predetermined period of time; obtaining data quantifying digital component distribution in the first region during a second predetermined period of time; predicting, using the machine learning model, a predicted second outcome quantifying digital component distribution in the first region during the second predetermined period of time; comparing the predicted second outcome during the second predetermined period of time with the data quantifying digital component distribution in the first region during a second predetermined period of time; and adjusting the digital component distribution criteria for the first region based on the comparison.

Methods can include using the machine learning model to generate predicted data quantifying digital component distribution in the second region during the second predetermined period of time; comparing data quantifying digital component distribution in the second region during a second predetermined period of time and the predicted data quantifying digital component distribution in the second region during the second predetermined period of time; and adjusting the digital component distribution criteria for the second region.

Methods can include the first predetermined period of time to be a time period prior to altering one or more digital component distribution criteria.

Methods can include generating the machine learning model to include training the machine learning model using the data quantifying digital component distribution in the first region during the first predetermined period of time and the data quantifying digital component distribution in the second regions during the first predetermined period of time.

Methods can include the second predetermined period of time to be a time period after altering the one or more digital component distribution criteria.

Methods can include comparing the data quantifying digital component distribution in the first region during the second predetermined period of time with the predicted data quantifying digital component distribution in the first region during the second predetermined period of time to include subtracting the data quantifying digital component distribution in the first region during the second predetermined period of time from the predicted data quantifying digital component distribution in the first region during the second predetermined period of time.

Methods can include the first region to be different from the one or more second regions.

Methods can include the machine learning model to be a time-series model.

Methods can include the time-series model to be a multivariate Bayesian state space model.

Particular embodiments of the subject matter described in this specification can be implemented so as to realize one or more of the following advantages. Distribution of digital components is subject to one or more distribution criteria and altering these distribution criteria directly impacts how digital components are distributed to client devices. Existing techniques such as A/B testing of evaluating such changes to distribution criteria are expensive and time consuming since only a portion of the population is subjected to the altered distribution criteria so as to obtain performance data of the altered distribution criteria. This is then compared to the performance data of the other portion of the population for which the distribution criteria was not altered. This technique of evaluation is not accurate since only a portion of the population is subjected to the changes to distribution criteria. In contrast, the techniques and methods described in this specification can be used to generate a machine learning model to predict the performance of the existing distribution criteria. In some implementations, the method allows for altering the distribution criteria for the entire population and comparing the performance of the distribution of digital components of the entire population under the altered and unaltered distribution criteria.

In some implementations, the methods described in this specification do not require a machine learning model to be retrained for predicting the performance of digital component distribution in different geographical areas thereby saving time and valuable computing resources. Instead, the machine learning model can be trained to predict the performance of digital component distribution across all geographical areas while taking into account any correlation that might exist between the performances between different geographical areas.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which digital components are distributed.

FIG. 2 is a graph illustrating an example of the effects of altering one or more distribution criteria.

FIG. 3 is a flow diagram of an example process for evaluating the performance of the distribution criteria based on the performance of the distribution criteria in other geographical regions.

FIG. 4 is a block diagram of an example computer system that can be used to perform operations described.

### DETAILED DESCRIPTION

This document covers methods, systems, apparatus, and computer readable media that are used to facilitate analyzing the effectiveness of altering digital component distribution criteria by counterfactually predicting the distribution of digital components to client devices located in multiple geographic locations that would have been observed if the digital component distribution criteria that guide the distribution of digital components had not been altered.

As used throughout this document, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include advertising information, such that an advertisement is a type of digital component.

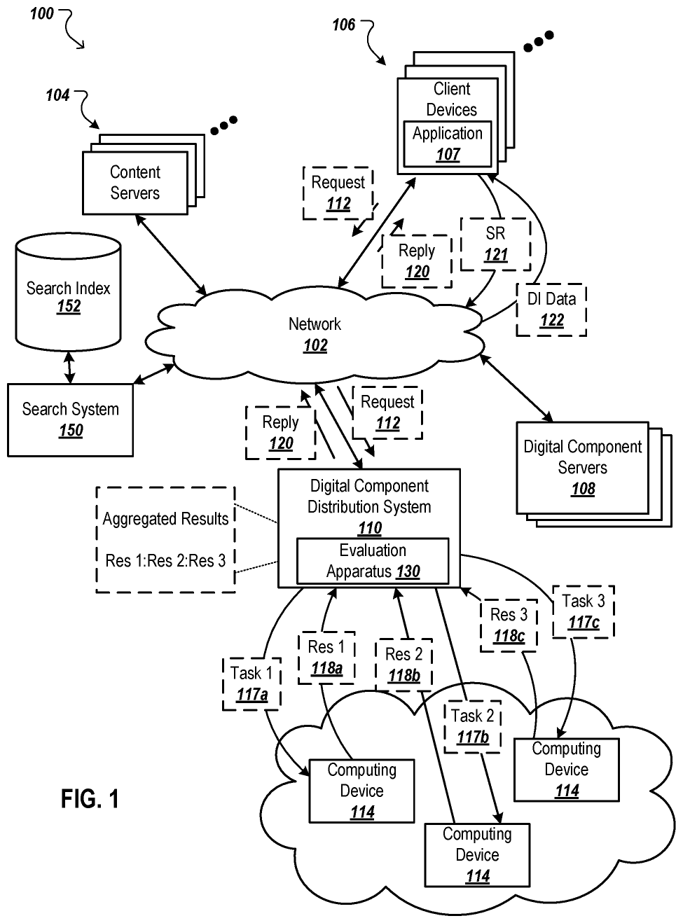

FIG. 1 is a block diagram of an example environment 100 in which content is distributed. As described in more detail below, users are exposed to a variety of online content in the environment 100, and the techniques discussed throughout this document can determine the incremental effect of each of those exposures to a user performing a specified target action.

The example environment 100 includes a network 102, such as a local area network (LAN), a wide area network (WAN), the Internet, or a combination thereof. The network 102 connects content servers 104, client devices 106, digital component servers 108, and a digital component distribution system 110 (also referred to as a component distribution system).

An electronic document is data that presents a set of content at a client device 106. Examples of electronic documents include webpages, word processing documents, portable document format (PDF) documents, images, videos, search results pages, and feed sources. Native applications (e.g., “apps”), such as applications installed on mobile, tablet, or desktop computing devices are also examples of electronic documents. Electronic documents can be provided to user devices 106 by content servers 104. For example, the content servers 104 can include servers that host publisher websites. In this example, the client device 106 can initiate a request for a given publisher webpage, and the content server 104 that hosts the given publisher webpage can respond to the request by sending machine executable instructions that initiate presentation of the given webpage at the client device 106.

In another example, the content servers 104 can include app servers from which client devices 106 can download apps. In this example, the client device 106 can download files required to install an app at the client device 106, and then execute the downloaded app locally. The app can present organic content, e.g., content specified by a developer of the app, and in some cases can also present one or more digital components (e.g., content created/distributed by a third party) that are obtained from a digital component server 108, and inserted into the app while the app is being executed at the client device 106.

Electronic documents can include a variety of content. For example, an electronic document can include static content (e.g., text or other specified content) that is within the electronic document itself and/or does not change over time. Electronic documents can also include dynamic content that may change over time or on a per-request basis. For example, a publisher of a given electronic document can maintain a data source that is used to populate portions of the electronic document. In this example, the given electronic document can include a tag or script that causes the user device 106 to request content from the data source when the given electronic document is processed (e.g., rendered or executed) by a client device 106. The client device 106 integrates the content obtained from the data source into the given electronic document to create a composite electronic document including the content obtained from the data source.

In some situations, a given electronic document can include a digital component tag or digital component script that references the digital component distribution system 110. In these situations, the digital component tag or digital component script is executed by the client device 106 when the given electronic document is processed by the client device 106. Execution of the digital component tag or digital component script configures the client device 106 to generate a request for digital components 112 (referred to as a “component request”), which is transmitted over the network 102 to the digital component distribution system 110. For example, the digital component tag or digital component script can enable the user device 106 to generate a packetized data request including a header and payload data. The component request 112 can include event data specifying features such as a name (or network location) of a server from which the digital component is being requested, a name (or network location) of the requesting device (e.g., the user device 106), and/or information that the digital component distribution system 110 can use to select one or more digital components provided in response to the request. The component request 112 is transmitted, by the user device 106, over the network 102 (e.g., a telecommunications network) to a server of the digital component distribution system 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the digital component distribution system 110. Similarly, event data specifying keywords associated with the electronic document (“document keywords”) or entities (e.g., people, places, or things) that are referenced by the electronic document can also be included in the component request 112 (e.g., as payload data) and provided to the digital component distribution system 110 to facilitate identification of digital components that are eligible for presentation with the electronic document. The event data can also include a search query that was submitted from the user device 106 to obtain a search results page, and/or data specifying search results and/or textual, audible, or other visual content that is included in the search results.

Component requests 112 can also include event data related to other information, such as information that a user of the user device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The component distribution system 110, which includes one or more digital component distribution servers, chooses digital components that will be presented with the given electronic document in response to receiving the component request 112 and/or using information included in the component request 112. In some implementations, a digital component is selected in less than a second to avoid errors that could be caused by delayed selection of the digital component. For example, delays in providing digital components in response to a component request 112 can result in page load errors at the user device 106 or cause portions of the electronic document to remain unpopulated even after other portions of the electronic document are presented at the client device 106. Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

To facilitate searching of electronic documents, the environment 100 can include a search system 150 that identifies the electronic documents by crawling and indexing the electronic documents (e.g., indexed based on the crawled content of the electronic documents). Data about the electronic documents can be indexed based on the electronic document with which the data are associated. The indexed and, optionally, cached copies of the electronic documents are stored in a search index 152 (e.g., hardware memory device(s)). Data that are associated with an electronic document is data that represents content included in the electronic document and/or metadata for the electronic document.

Client devices 106 can submit search queries to the search system 150 over the network 102. In response, the search system 150 accesses the search index 152 to identify electronic documents that are relevant to the search query. The search system 150 identifies the electronic documents in the form of search results and returns the search results to the client device 106 in search results page. A search result is data generated by the search system 150 that identifies an electronic document that is responsive (e.g., relevant) to a particular search query, and includes an active link (e.g., hypertext link) that causes a client device to request data from a specified location in response to user interaction with the search result. An example search result can include a web page title, a snippet of text or a portion of an image extracted from the web page, and the URL of the web page. Another example search result can include a title of a downloadable application, a snippet of text describing the downloadable application, an image depicting a user interface of the downloadable application, and/or a URL to a location from which the application can be downloaded to the client device 106. Another example search result can include a title of streaming media, a snippet of text describing the streaming media, an image depicting contents of the streaming media, and/or a URL to a location from which the streaming media can be downloaded to the client device 106. Like other electronic documents search results pages can include one or more slots in which digital components (e.g., advertisements, video clips, audio clips, images, or other digital components) can be presented.

In some implementations, the digital component distribution system 110 is implemented in a distributed computing system that includes, for example, a server and a set of multiple computing devices 114 that are interconnected and identify and distribute digital components in response to component requests 112. The set of multiple computing devices 114 operate together to identify a set of digital components that are eligible to be presented in the electronic document from among a corpus of millions of available digital components.

In some implementations, the digital component distribution system 110 implements different techniques for selecting and distributing digital components. For example, digital components can include corresponding distribution parameters based on one or more distribution criteria that contribute to (e.g., condition or limit) the selection, distribution and transmission of the corresponding digital component. For example, the distribution parameters can contribute to the transmission of a digital component by requiring that a component request include at least one criterion that matches (e.g., either exactly or with some pre-specified level of similarity) one of the distribution parameters of the digital component.

In another example, the distribution parameters for a particular digital component can include distribution keywords that must be matched (e.g., by electronic documents, document keywords, or terms specified in the component request 112) in order for the digital components to be eligible for presentation. The distribution parameters can also require that the component request 112 include information specifying a particular geographic region (e.g., country or state) and/or information specifying that the component request 112 originated at a particular type of client device 106 (e.g., mobile device or tablet device) in order for the component item to be eligible for presentation. The distribution parameters can also specify an eligibility value (e.g., rank, score or some other specified value) that is used for evaluating the eligibility of the component item for selection/distribution/transmission (e.g., among other available digital components), as discussed in more detail below. In some situations, the eligibility value can be based on an amount that will be submitted when a specific event is attributed to the digital component item (e.g., presentation of the digital component).

The identification of the eligible digital components can be segmented into multiple tasks 117a-117c that are then assigned among computing devices within the set of multiple computing devices 114. For example, different computing devices in the set 114 can each analyze a different digital component to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the digital component distribution system 110. For example, the results 118a-118c provided by each of the computing devices in the set 114 may identify a subset of digital component items that are eligible for distribution in response to the component request and/or a subset of the digital components that have certain distribution parameters. The identification of the subset of digital components can include, for example, comparing the event data to the distribution parameters, and identifying the subset of digital components having distribution parameters that match at least some features of the event data.

The digital component distribution system 110 aggregates the results 118a-118c received from the set of multiple computing devices 114 and uses information associated with the aggregated results to select one or more digital components that will be provided in response to the component request 112. For example, the digital component distribution system 110 can select a set of winning digital components (one or more digital components) based on the outcome of one or more digital component evaluation processes. In turn, the digital component distribution system 110 can generate and transmit, over the network 102, reply data 120 (e.g., digital data representing a reply) that enable the client device 106 to integrate the set of winning digital component into the given electronic document, such that the set of winning digital components and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a URL) and a script that causes the client device 106 to transmit a server request (SR) 121 to the digital component server 108 to obtain a given winning digital component from the digital component server 108. In response to the server request 121, the digital component server 108 will identify the given winning digital component specified in the server request 121 and transmit, to the client device 106, digital component data 122 (DI Data) that presents the given winning digital component in the electronic document at the client device 106.

In some situations, distribution parameters for digital component distribution may include user characteristics such as demographic information, user interests, and/or other information that can be used to personalize the user's online experience. In some situations, these characteristics and/or information regarding the user of the client device 106 is readily available. For example, content platforms such as the content server 104 or the search system 150 may allow the user to register with the content platform by providing such user information. In another example, the content platform can use cookies to identify client devices, which can store information about the user's online activity and/or user characteristics.

In some implementations, the digital component distribution system 110 can alter the one or more digital component distribution criteria (from now on referred to as only distribution criteria) by altering the one or more digital component distribution parameters. For example, assume that an existing distribution criteria can set the selection and distribution of digital components based on a set of keywords provided by the digital component server 108. When the user of the client device 106 provides a search query to the search system 150, the search system 150 can communicate with the digital component distribution system 110 to select digital components by comparing the keywords of the search query to the set of keywords associated with digital components from a digital component server 108. In such situations, the digital component distribution system 110 (or the digital component server 108) can alter the distribution criteria by altering the set of keywords by adding more keywords in the set of keywords to expand the selection criteria of digital components based on the altered set of keywords. In another situation, the digital component distribution system 110 (or the digital component server 108) can alter the distribution criteria by removing and/or replacing keywords in the set of keywords so as to cap the selection criteria of the digital components.

The digital component distribution system 110 can be configured to monitor the performance of the distribution of digital components to the client devices 106. Since altering the distribution criteria is a crucial decision for the digital component distribution system 110 and the digital component server 108, the digital component distribution system 110 (or the digital component server 108) can perform an analysis to determine the effectiveness of altering the distribution criteria. For example, the performance of the distribution of digital components can be based on impression count (e.g., how many times digital components were presented on client devices 106) or an interaction count (e.g., click count that indicates as to how many times the presented digital components was clicked by the users of the client devices 106). Other parameters of measuring the performance can be based on geographic locations of client devices 106 where digital components are presented, the types of client devices 106 on which the digital components are presented etc.

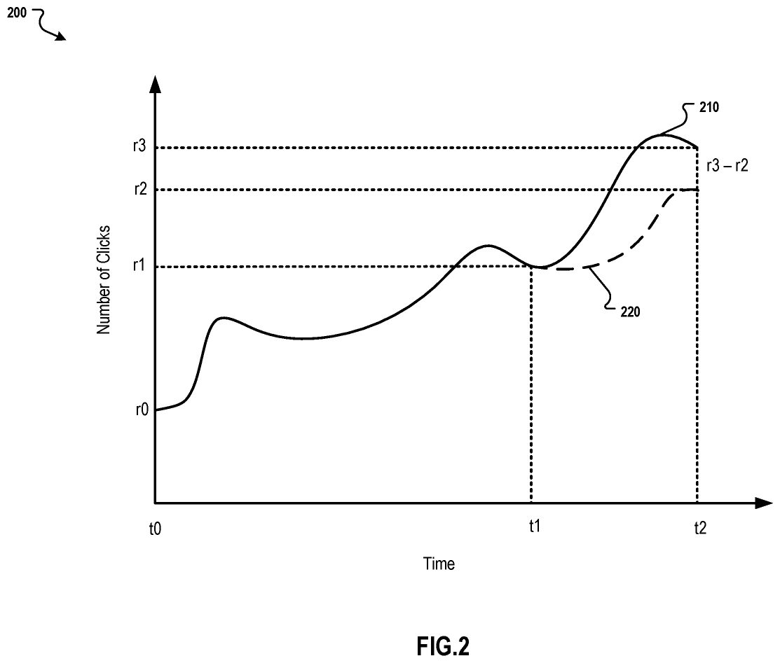

These techniques of measuring the performance of digital component distribution are acceptable when the performance is measured across different time periods. For example, the techniques mentioned above can be used to compare how well (or poorly) was the distribution of digital components during a first time period (for e.g., the month of July) and a second time period (for e.g., the month of August). However, such a comparison is not possible if the digital component distribution system 110 (or the digital component server 108) alters the distribution criteria of the digital components. This is further explained with reference to FIG. 2.

FIG. 2 is a graph 200 illustrating an example of the effects of altering one or more distribution criteria. FIG. 2 plots the interaction count such as the number of clicks received from the users of the client devices 106 in response to presenting digital components on client devices 106. In other words, FIG. 2 shows the change in the number of clicks received from the users of the client devices 106 between time-interval t0-t2.

As seen in the graph 200 and with reference to the solid line 210, the number of clicks at time t0 is r0. As the time progresses, the number of clicks changes wherein at time t1, the number of clicks is r1. The distribution of digital components during time interval t0 and t1 is according to a preset distribution criteria. Further in this example, at time t1, the digital component distribution system 110 (or the digital component server 108) alters the distribution criteria thereby altering the distribution of digital components. In this example, it can be seen that in time t2, the number of clicks has reached r3.

In such situations, the digital component distribution system 110 (or the digital component server 108) may want to know the performance of distribution of digital components under the influence of the altered distribution criteria. For example, the digital component distribution system 110 (or the digital component server 108) can be interested in knowing how well (or poorly) the distribution of the digital components under the influence of the altered distribution criteria performs when compared to the performance of the preset distribution criteria. For example, let us assume that the digital component distribution system 110 (or the digital component server 108) did not alter the preset distribution criteria at time t1, and that the distribution of digital components were to continue according to the preset distribution criteria, then the number of clicks at time t2 is r2 (with reference to dashed line 220). The difference in the number of clicks r3-r2 would represent how well (or poorly) the altered distribution criteria performed. For example, if the value of r3-r2 is positive then the digital component distribution system 110 (or the digital component server 108) can determine that the altered distribution criteria performed better than the preset distribution criteria. Similarly, if the value of r3-r2 is negative then the digital component distribution system 110 (or the digital component server 108) can determine that the altered distribution criteria performed worse than the preset distribution criteria.

As seen in the above example, evaluating the performance of the altered distribution criteria requires performance data of the altered distribution criteria and performance data of the preset distribution criteria. Performing such an evaluation is not possible since after altering the distribution criteria, the only observable data is the performance of the altered distribution criteria i.e. the number of clicks received after altering the preset distribution criteria. To evaluate the performance, the digital component distribution system 110 can include an evaluation apparatus 130 configured to predict the performance of the distribution of digital components that would have been observed if the preset distribution criteria had not been altered. The following description relates to techniques and methods implemented by the evaluation apparatus 130.

In some implementations, the evaluation apparatus 130 can evaluate the performance of the distribution criteria based on the performance of the distribution criteria in another group, such as, e.g., performance in client devices located in another geographical region or regions. In such implementations, the evaluation apparatus 130 can consider any correlation that might exist between the performances of the distribution criteria across different groups, such as across groups of client devices, each group being in a different geographic location. For example, the digital component distribution system 110 (or the digital component server 104) can alter the distribution criteria of a first geographical area (also referred to as a first region) such as New York and a second geographical area (also referred to as a second region) such as San Francisco. Since both New York and San Francisco are large metropolitan cities in the United States of America, there might an underlying correlation between the distributions of digital components in each individual city irrespective of the distribution criteria. In this example, the digital component distribution system 110 (or the digital component server 108) can use historical data of the performance of distribution criteria in New York and San Francisco to predict the performance of the distribution of digital components that would have been observed if the distribution criteria had not been altered in New York or San Francisco. Though the above example and the following description has been explained with reference to two geographical regions, the techniques and methods can be implemented to any number of geographical areas. The techniques and methods can also be used in scenarios where one or more features can be used to segregate the client devices 106 into groups. For example, client devices 106 across different time intervals or client devices 106 of different types. In fact the techniques and methods can be used in scenarios other than distribution of digital components. For example, the techniques and methods can be used to evaluate stock market activity after changes in one or more stock market policies.

In some implementations, the evaluation apparatus 130 is configured to obtain historical data quantifying digital component distribution in a first region during a first predetermined period of time. With reference to the plot presented with reference to FIG. 2, the first predetermined period of time is the time period t0-t1 which is prior to altering the preset distribution criteria. For example, assume that the digital component distribution system 110 (or the digital component server 104) has a preset distribution criteria for a first region such as New York. The evaluation apparatus 130 can obtain historical data indicating the quantity (or number) of clicks received from the users of the client devices 106 located in the New York area where digital components were distributed according to the preset distribution criteria. The historical data can be of the form of a time-series where each sample indicates a time-interval within the first predetermined time period and the number of clicks received in that time-interval.

In some implementations, the evaluation apparatus 130 is further configured to obtain historical data quantifying digital component distribution in a second region during a first predetermined period of time. For example, assume that the digital component distribution system 110 (or the digital component server 104) has a preset distribution criteria for a second region such as San Francisco. The evaluation apparatus 130 can obtain historical data indicating the quantity (or number) of clicks received from the users of the client devices 106 located in San Francisco where digital components were distributed according to the preset distribution criteria.

In some implementations, the evaluation apparatus 130 can implement a machine learning model to predict the performance of the altered distribution criteria. The machine learning model can be any model as deemed necessary by the system administrator. In this example, the machine learning model is a time-series model that is trained on historical data quantifying digital component distribution in the first and the second region during the first predetermined period of time. For example, the evaluation apparatus 130 can create a training dataset using historical data of New York and San Francisco such that each training sample of the training dataset is time stamped along with the performance of digital component distribution in New York and San Francisco. In formal terms the training dataset is a time series yₜ⁰:=[y₁ₜ⁰ . . . y_{Nt}⁰]′∈R^{N} that denotes a vector which represents the performance of the preset distribution criteria at time t in N geographic locations. To elaborate further, an element yₙₜ⁰ indicates the performance of digital component distribution at time t in the n-th geographical location. The suffix 0 represents that the performance of digital component distribution is based on the unaltered distribution criteria.

In some implementations, the time-series model implemented by the evaluation apparatus 130 is a multivariate Bayesian state space model. In some implementations, the multivariate Bayesian state space model can take the following form

y₀^{t}=(Zₜ*⊗I_{N})αₜ+∈ₜ ∈ₜ˜N(0,Hₜ) (1)

αₜ₊₁=(Tₜ*⊗I_{N})αₜ+(Rₜ*⊗I_{N})ηₜ ηₜ˜N(0,Qₜ) (2)

where equation (1) is referred to as an observation equation that links the vector y₀^{t} at time t to vector αₜ of unobserved latent states and equation (2) is referred to as an transition equation that defines how the latent states evolve over time.

The model matrices Zₜ*, Tₜ* and Rₜ* includes values that are typically are set as 0 and 1. Zₜ* is a N×M matrix where is M corresponds to the number of hidden states of the Bayesian state space model, Tₜ* is a M×M transition matrix, and Rₜ* is a M×P control matrix. Equation 1 also defines a zero-mean random normal disturbance vector ∈ₜ based on a N×N covariance matrix Hₜ and Equation 2 defines a zero-mean random normal disturbance vector ηₜ based on a P×P covariance matrix Qₜ. Equation 1 and 2 further uses Kronecker product ⊗ to generalize the Bayesian state space model across N geographical locations where I_{N} is a N×N identity matrix that allows the Bayesian state space model to share information such as any correlation that might exist between the performances of the distribution criteria in different geographic locations.

The multivariate Bayesian state space model described using equations (1) and (2) also includes a trend component, a seasonal component and a regression component. In general, the trend component is described using first-order local level model as described below

yₜ⁰=μₜ^{{1}}+∈ₜ ∈ₜ˜N(0,H) (3)

μₜ₊₁^{{1}}=μₜ^{{1}}+η_{μ}_{ₜ}^{{1}} η_{μ}_{ₜ}^{{1}}˜N(0,Q_{μ}^{{1}}) (4)

where the expected levels μₜ^{{1}}∈R^{N} evolve over time according to a random walk with N×N covariance matrix Q_{μ}^{{1}}. In relation to equations (1) and (2), the first order local level model can be generated into the multivariate Bayesian state space model by setting αₜ=μₜ^{{1}}, Z*=[1], H=H_{μ}, T*=[1], R*=[1], and Q=Q_{μ}^{{1}}.

In general, the second-order local linear model that is more suitable for modelling trends which exhibit linear performance growth within short time periods can be expressed as follows

yₜ⁰=μₜ^{{1}}+∈ₜ ∈ₜ˜N(0,H_{μ}) (4)

μₜ₊₁^{{1}}+μₜ^{{1}}+μₜ^{{2}}+η_{μ}_{ₜ}^{{1}} η_{μ}_{ₜ}^{{1}}˜N(0,Q_{μ}^{{1}}) (5)

μₜ₊₁^{{2}}=μₜ^{{2}}+η_{μ}_{ₜ}^{{2}} η_{μ}_{ₜ}^{{2}}˜N(0,Q_{μ}^{{2}}) (6)

where μₜ^{{2}}∈R^{N} is a slope that varies overtime via random walk with N×N covariance matrix Q_{μ}^{{2}}. In relation to equations (1) and (2), the second-order local linear model can be expressed by setting

$$\begin{matrix}\text{?} = [ \begin{matrix}\text{?} \\ ⋮ \\ \text{?}\end{matrix} ] , & \text{?} = [ \text{?} ] , & H = \text{?} ,\end{matrix} \qquad ( 7 )$$

$$\begin{matrix}\text{?} = [ \text{?} ] , & \text{?} = diag ( \text{?} ) , & Q = diag ( \text{?} ) .\end{matrix} \qquad ( 8 )$$

$$\text{?} \text{indicates text missing or illegible when filed}$$

In general, the regression component of a state space model can be represented as

yₜ⁰=Σₖ₌₁^{K}βₜ^{{k}}xₖₜ+∈ₜ ∈ₜ˜N(0,H_{β}) (9)

βₜ₊₁^{{1}}=βₜ^{{1}}+η_{β}_{ₜ}^{{1}} η_{β}_{ₜ}^{{1}}˜N(0,Q_{β}^{{1}}) (10)

βₜ₊₁^{{K}}=βₜ^{{K}}+η_{β}_{ₜ}^{{K}} η_{β}_{ₜ}^{{K}}˜N(0,Q_{β}^{{K}}) (11)

where βₜ^{{k}}=[β₁ₜ^{{k}} . . . β_{Nt}^{{k}}]′∈R^{N} is a column vector of regression coefficients. In relation to equation 1 and 2, the regression component can be represented as a state space model as

αₜ=[βₜ^{{1}}, . . . βₜ^{{K}}]′ (12)

Zₜ*=[x₁ₜ . . . x_{Kt}] (13)

H=H_{β} (14)

T*=I_{K} (15)

R*=I_{K} (16)

Q=diag(Q_{β}^{{1}} . . . Q_{β}^{{K}}) (17)

As mentioned before, evaluating the performance of the altered distribution criteria requires performance data indicating distribution of digital components under the altered distribution criteria and the preset distribution criteria. In some implementations, the evaluation apparatus 130 is configured to obtain data quantifying performance of distribution criteria in a first group (e.g., a first region) during a second predetermined period of time. For example, assume that the digital component distribution system 110 (or the digital component server 108) alters the distribution criteria for the first region, e.g., New York at some point of time. Following the alteration of distribution criteria, distribution of digital components in New York occurs based on the altered distribution criteria and the evaluation apparatus 130 collects data indicating performance of the altered distribution criteria. With reference to the example provided in FIG. 2, t1-t2 is the time period after altering the distribution criteria and is referred to as the second predetermined period of time. In some implementations, the data quantifying performance of distribution criteria in the first region can be a time series data indicating the performance for each time interval in the second predetermined period of time. For example, if the time duration of the second predetermined period of time t1-t2 is 48 hours, the data quantifying performance of distribution criteria can be recorded at hour time intervals, thereby generating a time series that includes 48 time-stamped samples. Other time intervals can be used instead.

In some implementations, the evaluation apparatus 130 can use the machine learning model to predict the performance of the preset distribution criteria for one or more of the N geographical regions in the second predetermined period of time. For example, the evaluation apparatus 130 can use the machine learning model to predict the performance of distribution of digital component if the preset distribution criteria was unaltered in the second predetermined period of time t1-t2. For example, if the time duration of the second predetermined period of time t1-t2 is 48 hours, the data quantifying performance of the preset distribution criteria can be predicted at hour time intervals, thereby generating a time series that includes 48 time-stamped samples. Other time intervals can be used instead.

In some implementations, after predicting the performance of the preset distribution criteria for one or more of the N geographical regions in the second predetermined period of time, the evaluation apparatus 130 can compare the predicted performance of the preset distribution criteria in the first region to the recorded performance of the altered distribution criteria in the first region to determine the effectiveness of the altered distribution criteria. For example, if the recorded performance of the altered distribution criteria in the first region for a particular time interval includes a greater (or fewer) number of defined actions than the predicted performance of the preset distribution criteria, the evaluation apparatus 130 can determine that the altered distribution criteria performed better than the preset distribution criteria for the particular time interval. For example, assume that the second predetermined period of time is 48 hours after the preset distribution criteria is altered. The evaluation apparatus 130 can predict the performance (e.g., predicted number of clicks) that occurs for the preset distribution criteria for each of the 48 one hour time intervals and also record the actual performance (e.g., actual number of clicks) that occurs for the altered distribution criteria for each of those one hour time intervals. The evaluation apparatus 130 can compare the respective performances for each of the 48 one hour time intervals to determine whether the altered distribution criteria performed better (or worse) than the preset distribution criteria in each of the one hour time intervals. For example, if, for a particular time interval, the actual performance for the altered distribution criteria includes a recorded number of clicks and that recorded number of clicks is more than the predicted number of clicks for the preset distribution criteria during the same time interval, the evaluation apparatus 130 can determine that the altered distribution criteria performed better than the preset distribution criteria for the time interval. Conversely, if, for a particular time interval, the predicted performance for the preset distribution criteria includes a predicted number of clicks and that predicted number of clicks is more than the recorded number of clicks for the altered distribution criteria during the same time interval, the evaluation apparatus 130 can determine that the altered distribution criteria did not perform as well as the preset distribution criteria for the particular time interval. In some implementations, the evaluation apparatus 130 can compute the cumulative performance of the altered distribution criteria and the preset distribution criteria across all time intervals in the second predetermined period of time. For example, the evaluation apparatus 130 can compute the sum of the performances of each of the 48 one hour time intervals in the second predetermined period of time and compare the cumulative performances of the altered distribution criteria and the preset distribution criteria to determine whether the altered distribution criteria performed better (or worse) than the preset distribution criteria for the entire second predetermined period of time.

In some implementations, the evaluation apparatus 130 can also quantify how much better (or worse) the altered distribution criteria performed when compared to the preset distribution criteria. For example, the evaluation apparatus 130 can compare the performances of the altered distribution criteria and the preset distribution criteria based on the individual components of trend and seasonality. For example, if the time duration of the second predetermined period of time t1-t2 is 48 hours and the time interval is 1 hour, the data quantifying performance of preset distribution criteria can be predicted for each hour thereby generating a time series that includes 48 time-stamped samples. By summing the predicted performance across the 48 time-stamped samples the evaluation apparatus 130 can compute the predictive cumulative performance of the preset distribution criteria. Similarly, the evaluation apparatus 130 can compute the cumulative performance of the altered distribution criteria. The evaluation apparatus 130 can then compare the cumulative performance to determine whether the altered distribution criteria performed better (or worse) than the preset distribution criteria.

In some implementations, after determining whether the altered distribution criteria performed better (or worse) than the preset distribution criteria, the evaluation apparatus 130 can notify the system administrator regarding its findings along with a recommendation to modify or maintain the changes made to the preset distribution criteria at time t1. For example, if the evaluation apparatus 130 determines that the altered distribution criteria performed worse than the preset distribution criteria, the evaluation apparatus 130 can recommend rolling back the altered distribution criteria to the preset distribution criteria. In some implementations, the evaluation apparatus 130 can also recommend one or more changes to the altered distribution criteria based on the performance of the predicted distribution criteria and the altered distribution criteria. For example, the evaluation apparatus 130 can identify one or more settings in the altered distribution criteria that if changed can improve the performance of the altered distribution criteria.

In some implementations, the evaluation apparatus 130 can use the machine learning model to evaluate the performance of distribution of digital components under the altered distribution criteria in the second group (e.g., second region) other than the first group (e.g., the first region). As described earlier, the evaluation apparatus 130 can use the machine learning model to predict the performance of the preset distribution criteria in the second predetermined period of time for each one or more of the N geographical regions that includes the first region and one or more of the second regions. For example, the machine learning model can be used to predict the performance of the preset distribution criteria for New York as well as San Francisco.

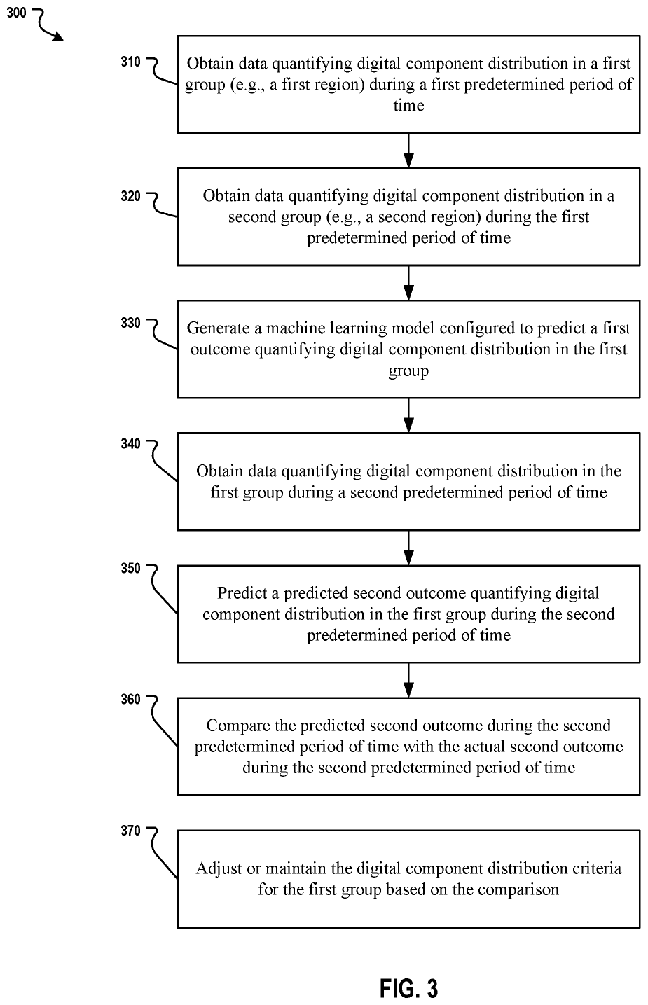

The evaluation apparatus 130 can record data quantifying digital component distribution in a second region during a second predetermined period of time and compare the predicted performance of the preset distribution criteria in the second region to the recorded performance of the altered distribution criteria in the second region to determine the effectiveness of the altered distribution criteria. For example, the evaluation apparatus 130 can use the machine learning model to predict the performance of the preset distribution criteria in San Francisco during the time interval t1-t2 based on the preset distribution criteria and also record the performance of the altered distribution criteria in San Francisco during the time interval t1-t2. After comparing the performances, the evaluation apparatus 130 can determine whether the altered distribution criteria performed better (or worse) than the preset distribution criteria. Based on the determination, the evaluation apparatus 130 can recommend rolling back the altered distribution criteria to the preset distribution criteria. In some implementations, the evaluation apparatus 130 can recommend to modify or maintain the changes made to the preset distribution criteria at time t1. FIG. 3 is a flow diagram of an example process 300 for evaluating the performance of the distribution criteria based on the performance of the distribution criteria in other groups, such as other geographical regions. Operations of the process 300 can be implemented, for example, by the evaluation apparatus 130. Operations of the process 300 can also be implemented as instructions stored on one or more computer readable media which may be non-transitory, and execution of the instructions by one or more data processing apparatus can cause the one or more data processing apparatus to perform the operations of the process 300.

The evaluations apparatus 130 obtains data quantifying digital component distribution in a first group (e.g., a first region) during a first predetermined period of time (310). For example, assume that the digital component distribution system 110 (or the digital component server 104) has a preset distribution criteria for a first region such as New York. The evaluation apparatus 130 can obtain historical data indicating the quantity (or number) of clicks received from the users of the client devices 106 located in the New York area where digital components were distributed according to the preset distribution criteria. The historical data can be of the form of a time-series where each sample indicates a time-interval within the first predetermined time period and the number of clicks received in that time-interval.

The evaluation apparatus 130 obtains data quantifying digital component distribution in a second group (e.g., a second region) during the first predetermined period of time (320). For example, assume that the digital component distribution system 110 (or the digital component server 104) has a preset distribution criteria for a second region such as San Francisco. The evaluation apparatus 130 can obtain historical data indicating the quantity (or number) of clicks received from the users of the client devices 106 located in San Francisco where digital components were distributed according to the preset distribution criteria.

The evaluation apparatus 130 generates a machine learning model that is configured to predict a first outcome quantifying digital component distribution in the first group (330). Evaluating the performance of the altered distribution criteria requires performance data of the altered distribution criteria and performance data of the preset distribution criteria. As explained herein, performing such an evaluation is not possible since after altering the distribution criteria, the only observable data is the performance of the altered distribution criteria, e.g., the number of clicks received after altering the preset distribution criteria. To evaluate the performance according to the present disclosure, the evaluation apparatus 130 can be configured to predict the performance of the distribution of digital components that would have been observed if the preset distribution criteria had not been altered.

To predict the performance of the altered distribution criteria the evaluation apparatus 130 can implement the machine learning model. The time series model is trained using data indicating the performances of digital component distribution in the first predetermined period of time for N geographical locations. For example, the machine learning model is a multivariate Bayesian time-series model (explained with reference to equations 1-17) that is trained on historical data quantifying digital component distribution in the first group (e.g., first region) and the second group (e.g., second region) during the first predetermined period of time. For example, the evaluation apparatus 130 can obtain a training dataset using historical data of New York and San Francisco such that each training sample of the training dataset is time stamped along with the performance of digital component distribution in New York and San Francisco.

To predict the performance of the altered distribution criteria the evaluation apparatus 130 can implement the machine learning model. The time series model is trained using data indicating the performances of digital component distribution in the first predetermined period of time for N geographical locations. For example, the machine learning model is a multivariate Bayesian time-series model (explained with reference to equations 1-17) that is trained on historical data quantifying digital component distribution in the first group (e.g., first region) and the second group (e.g., second region) during the first predetermined period of time. For example, the evaluation apparatus 130 can obtain a training dataset using historical data of New York and San Francisco such that each training sample of the training dataset is time stamped along with the performance of digital component distribution in New York and San Francisco.

The evaluation apparatus 130 obtains data quantifying digital component distribution in the first group during a second predetermined period of time (340). For example, assume that the digital component distribution system 110 (or the digital component server 104) alters the distribution criteria for the first region, e.g., New York at a point in time, t1. Subsequent to the alteration of the distribution criteria, the distribution of digital components in New York occurs based on the altered distribution criteria, and the evaluation apparatus 130 collects data indicating performance of the altered distribution criteria. With reference to the example provided in FIG. 2, t1-t2 is the time period after altering the distribution criteria and is referred to as the second predetermined period of time. The data quantifying performance of distribution criteria in the first region can be a time series data indicating the performance for each time interval in the second predetermined period of time. For example, if the time duration of the second predetermined period of time t1-t2 is 48 hours, the data quantifying performance of distribution criteria can be recorded for each hour thereby generating a time series that includes 48 time-stamped samples.

The evaluation apparatus 130 uses the machine learning model to predict a second outcome quantifying digital component distribution in the first group during the second predetermined period of time (350). For example, the evaluation apparatus 130 can use the machine learning model to predict the performance of distribution of digital component in the first region for e.g., New York if the preset distribution criteria was unaltered in the second predetermined period of time t1-t2. For example, if the time duration of the second predetermined period of time t1-t2 is 48 hours, the data quantifying performance of the preset distribution criteria can be predicted for each hour thereby generating a time series that includes 48 time-stamped samples.

The evaluation apparatus then compares the predicted second outcome during the second predetermined period of time with the actual second outcome during the second predetermined period of time (360). For example, After predicting the performance of the preset distribution criteria for each of the N geographical regions in the second predetermined period of time, the evaluation apparatus 130 can compare the predicted performance of the preset distribution criteria in the first region to the recorded performance of the altered distribution criteria in the first region to determine the effectiveness of the altered distribution criteria. For example, assume that the second predetermined period of time is 48 hours after the preset distribution criteria is altered. The evaluation apparatus 130 can predict the performance of the preset distribution criteria for each of the 48 one hour time intervals and also record the performance of the altered distribution criteria for each of those one hour time intervals. The evaluation apparatus 130 can compare the respective performances for each of the 48 one hour time intervals to determine whether the altered distribution criteria performed better (or worse) than the preset distribution criteria in each of the one hour time intervals. For example, if the performance such as the number of clicks recorded for one of the time intervals is more than the predicted number of clicks, the evaluation apparatus 130 can determine that the altered distribution criteria performed better than the preset distribution criteria for the time interval. Conversely, if the predicted performance of the preset distribution criteria is more than the recorded performance of the altered distribution criteria for a particular time interval, the evaluation apparatus 130 can determine that the altered distribution criteria did not perform as well as the preset distribution criteria for the particular time interval. In some implementations, the evaluation apparatus 130 can compute the cumulative performance of the altered distribution criteria and the preset distribution criteria across all time intervals in the second predetermined period of time. For example, the evaluation apparatus 130 can compute the sum of the performances of each of the 48 one hour time intervals in the second predetermined period of time and compare the cumulative performances of the altered distribution criteria and the preset distribution criteria to determine whether the altered distribution criteria performed better (or worse) than the preset distribution criteria for the entire second predetermined period of time.

In some implementations, the evaluation apparatus 130 can quantify how much better (or worse) altered distribution criteria performed when compared to the preset distribution criteria. For example, the evaluation apparatus 130 can compare the performances of the altered distribution criteria and the preset distribution criteria based on the individual components of trend and seasonality. For example, if the performance of distribution of digital components shows an increasing trend under both preset distribution criteria and the altered distribution criteria, the evaluation apparatus 130 can use the magnitude of the increase in trend under the preset distribution criteria and the altered distribution criteria to determine how much better (or worse) altered distribution criteria performed when compared to the preset distribution criteria. For example, if the trend during the first predetermined time period shows an average increase in 1000 clicks for each time interval and an average increase of 800 clicks for each time interval in the second predetermined period of time, the evaluation apparatus 130 can determine that the preset distribution criteria performed better than the altered distribution criteria. As for another example, the evaluation apparatus 130 can use the magnitude of seasonal changes in the performances of the preset distribution criteria and the altered distribution criteria to determine which distribution criteria performed better than the other.

In another implementation, the evaluation apparatus 130 can compute the cumulative performance of the altered distribution criteria and the preset distribution criteria across all time intervals in the second predetermined period of time. For example, if the time duration of the second predetermined period of time t1-t2 is 48 hours, the data quantifying performance of preset distribution criteria can be predicted for each hour thereby generating a time series that includes 48 time-stamped samples. By summing the predicted performance across the 48 time-stamped samples the evaluation apparatus 130 can compute the predictive cumulative performance of the preset distribution criteria. Similarly, the evaluation apparatus 130 can compute the cumulative performance of the altered distribution criteria. The evaluation apparatus 130 can then compare the cumulative performance to determine whether the altered distribution criteria performed better (or worse) than the preset distribution criteria.

The evaluation apparatus 130 adjusts or maintains the digital component distribution criteria for the first region based on the comparison (370). After determining whether the altered distribution criteria performed better (or worse) than the preset distribution criteria, the evaluation apparatus 130 can notify the system administrator regarding its findings along with a recommendation to modify or maintain the changes made to the preset distribution criteria at time t1. For example, if the evaluation apparatus 130 determines that the altered distribution criteria performed worse than the preset distribution criteria, the evaluation apparatus 130 can recommend rolling back the altered distribution criteria to the preset distribution criteria. In some implementations, the evaluation apparatus 130 can also recommend one or more changes to the altered distribution criteria based on the performance of the predicted distribution criteria and the altered distribution criteria. For example, the evaluation apparatus 130 can identify one or more settings in the altered distribution criteria that if changed can improve the performance of the altered distribution criteria.

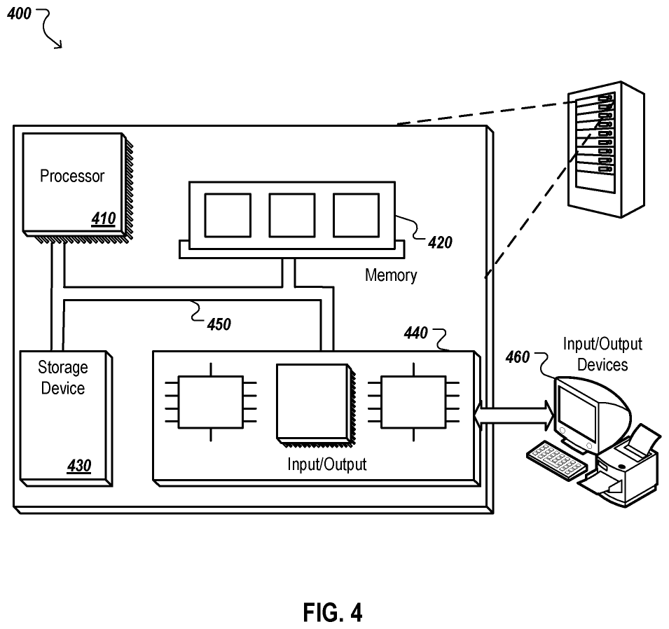

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In some implementations, the memory 420 is a volatile memory unit. In another implementation, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 40 provides input/output operations for the system 600. In some implementations, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to external devices 460, e.g., keyboard, printer and display devices. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method of distributing digital components to client devices, comprising:
obtaining, based on digital component distribution criteria, data quantifying digital component distribution in a first region during a first predetermined period of time;
obtaining data quantifying digital component distribution in a second region during the first predetermined period of time;
generating a machine learning model that is configured to predict a first outcome quantifying digital component distribution in the first region based on a correlation between the data quantifying digital component distribution in the first region during the first predetermined period of time and the data quantifying digital component distribution in the second region during the first predetermined period of time;
obtaining data quantifying digital component distribution in the first region during a second predetermined period of time;
predicting, using the machine learning model, a predicted second outcome quantifying digital component distribution in the first region during the second predetermined period of time;
comparing the predicted second outcome during the second predetermined period of time with the data quantifying digital component distribution in the first region during a second predetermined period of time; and
adjusting the digital component distribution criteria for the first region based on the comparison.

2. The computer implemented-method of claim 1 further comprises:
generating, using the machine learning model, predicted data quantifying digital component distribution in the second region during the second predetermined period of time;
comparing data quantifying digital component distribution in the second region during a second predetermined period of time and the predicted data quantifying digital component distribution in the second region during the second predetermined period of time; and
adjusting the digital component distribution criteria for the second region.

3. The computer-implemented method of claim 1, wherein the first predetermined period of time is a time period prior to altering one or more digital component distribution criteria.

4. The computer-implemented method of claim 1, wherein generating the machine learning model comprises training the machine learning model using the data quantifying digital component distribution in the first region during the first predetermined period of time and the data quantifying digital component distribution in the second regions during the first predetermined period of time.

5. The computer-implemented method of claim 1, wherein the second predetermined period of time is a time period after altering the one or more digital component distribution criteria.

6. The computer-implemented method of claim 1, wherein comparing the data quantifying digital component distribution in the first region during the second predetermined period of time with the predicted data quantifying digital component distribution in the first region during the second predetermined period of time comprises
subtracting the data quantifying digital component distribution in the first region during the second predetermined period of time from the predicted data quantifying digital component distribution in the first region during the second predetermined period of time.

7. The computer-implemented method of claim 1, wherein the first region is different from the one or more second regions.

8. The computer-implemented method of claim 1, wherein the machine learning model is a time-series model.

9. The computer-implemented method of claim 8, wherein the time-series model is a multivariate Bayesian state space model.

10. A system, comprising:
obtaining, based on digital component distribution criteria, data quantifying digital component distribution in a first region during a first predetermined period of time;
obtaining data quantifying digital component distribution in a second region during the first predetermined period of time;
generating a machine learning model that is configured to predict a first outcome quantifying digital component distribution in the first region based on a correlation between the data quantifying digital component distribution in the first region during the first predetermined period of time and the data quantifying digital component distribution in the second region during the first predetermined period of time;
obtaining data quantifying digital component distribution in the first region during a second predetermined period of time;
predicting, using the machine learning model, a predicted second outcome quantifying digital component distribution in the first region during the second predetermined period of time;
comparing the predicted second outcome during the second predetermined period of time with the data quantifying digital component distribution in the first region during a second predetermined period of time; and
adjusting the digital component distribution criteria for the first region based on the comparison.

11. The system of claim 10 further comprises:
generating, using the machine learning model, predicted data quantifying digital component distribution in the second region during the second predetermined period of time;
comparing data quantifying digital component distribution in the second region during a second predetermined period of time and the predicted data quantifying digital component distribution in the second region during the second predetermined period of time; and
adjusting the digital component distribution criteria for the second region.

12. The system of claim 10, wherein the first predetermined period of time is a time period prior to altering one or more digital component distribution criteria.

13. The system of claim 10, wherein generating the machine learning model comprises training the machine learning model using the data quantifying digital component distribution in the first region during the first predetermined period of time and the data quantifying digital component distribution in the second regions during the first predetermined period of time.

14. The system of claim 10, wherein the second predetermined period of time is a time period after altering the one or more digital component distribution criteria.

15. The system of claim 10, wherein comparing the data quantifying digital component distribution in the first region during the second predetermined period of time with the predicted data quantifying digital component distribution in the first region during the second predetermined period of time comprises subtracting the data quantifying digital component distribution in the first region during the second predetermined period of time from the predicted data quantifying digital component distribution in the first region during the second predetermined period of time.

16. The system of claim 10, wherein the first region is different from the one or more second regions.

17. The system of claim 10, wherein the machine learning model is a time-series model.

18. The system of claim 17, wherein the time-series model is a multivariate Bayesian state space model.

19. A non-transitory computer readable medium storing instructions that, when executed by one or more data processing apparatus, cause the one or more data processing apparatus to perform operations comprising:
obtaining, based on digital component distribution criteria, data quantifying digital component distribution in a first region during a first predetermined period of time;
obtaining data quantifying digital component distribution in a second region during the first predetermined period of time;
generating a machine learning model that is configured to predict a first outcome quantifying digital component distribution in the first region based on a correlation between the data quantifying digital component distribution in the first region during the first predetermined period of time and the data quantifying digital component distribution in the second region during the first predetermined period of time;
obtaining data quantifying digital component distribution in the first region during a second predetermined period of time;
predicting, using the machine learning model, a predicted second outcome quantifying digital component distribution in the first region during the second predetermined period of time;
comparing the predicted second outcome during the second predetermined period of time with the data quantifying digital component distribution in the first region during a second predetermined period of time; and
adjusting the digital component distribution criteria for the first region based on the comparison.

20. The non-transitory computer readable medium of claim 19 further comprises:
generating, using the machine learning model, predicted data quantifying digital component distribution in the second region during the second predetermined period of time;
comparing data quantifying digital component distribution in the second region during a second predetermined period of time and the predicted data quantifying digital component distribution in the second region during the second predetermined period of time; and
adjusting the digital component distribution criteria for the second region.
